(19) United States
(12) Patent Application Publication
(10) Pub. No.: US 2026/0113525 A1
(43) Pub. Date: Apr. 23, 2026

(54) ANTENNA MODULE, CAMERA MODULE AND ELECTRONIC DEVICE

(71) Applicant: WNC Corporation, Hsinchu (TW)

(72) Inventors: De Shao YAO, Hsinchu (TW); Chung-Che LIEN, Hsinchu (TW); Chia-Hao CHANG, Hsinchu (TW); Chih Feng TAI, Hsinchu (TW)

(21) Appl. No.: 19/317,450

(22) Filed: Sep. 3, 2025

Related U.S. Application Data
(60) Provisional application No. 63/691,498, filed on Sep. 6, 2024.

(30) Foreign Application Priority Data
Jun. 11, 2025 (TW) 114121816

(51) Int. Cl. H04N 23/54; H01Q 1/22; H01Q 1/38; H04N 23/55

(52) U.S. Cl. CPC H04N 23/54; H01Q 1/2283; H01Q 1/38; H04N 23/55

(57) ABSTRACT

An antenna module includes a first unit and a second unit. The first unit includes a first circuit board including a first signal trace and a first metal pad. The second unit includes a second circuit board including a second signal trace and a second metal pad, and the second circuit board is configured to dispose a feeding port thereon. Each of the first circuit board and the second circuit board extends in a first direction and a second direction, and the first circuit board and the second circuit board are arranged and connected along a third direction. A projection of the first circuit board along the third direction at least partially overlaps a projection of the second circuit board along the third direction. The second signal trace, the second metal pad, the first metal pad and the first signal trace are electrically connected in sequence.

### RELATED APPLICATIONS

This application claims the benefit of priorities to U.S. Provisional Application No. 63/691,498, filed on Sep. 6, 2024 and Taiwan Application Number 114121816, filed on Jun. 11, 2025. The entire content of the above identified applications is incorporated herein by reference.

### BACKGROUND

### Technical Field

The present disclosure relates to an antenna module, camera module and an electronic device, and more particularly, to an antenna module or a camera module with composite functions, and an electronic device having the antenna module or the camera module.

### Description of Related Art

With the advancement of technology, the demand for electronic device functionalities is increasing, thus increasing the cost and development complexity of electronic devices.

In conventional technology, electronic devices (such as laptops, tablets, smartphones, but not limited thereto) often have modules with different functions, such as antenna modules and camera modules, arranged around the screen bezel. At the same time, consumers also demand thin and lightweight dimensions, narrow bezel displays, and wireless communication bandwidth in electronic devices, making the design within the limited space of electronic devices more challenging to meet consumer needs.

In view of the above, there is a need to develop a module that can accommodate multiple functions meeting specific requirements within a limited space, while also satisfying the demands for thin and lightweight dimensions, narrow bezel displays, and wireless communication bandwidth in electronic devices.

### SUMMARY

The present disclosure provides an antenna module, a camera module, and an electronic device. The first unit of the antenna module or camera module includes a first circuit board, which includes a first signal trace configured for transmitting antenna signals. The first unit itself has an independent, non-antenna function (e.g. a camera function) and can also serve as an extension of the antenna, thereby also functioning as part of the antenna. By using the first unit as at least a part of the antenna radiator, space can be saved, and the antenna characteristics can be optimized by increasing the volume of the antenna radiator.

In one aspect, the present disclosure provides an antenna module that includes a first unit and a second unit. The first unit includes a first circuit board, which includes a first signal trace and a first metal pad. The second unit includes a second circuit board, which includes a second signal trace and a second metal pad, and the second circuit board is configured for disposing a feeding port thereon. Each of the first circuit board and the second circuit board extends in a first direction and a second direction, and the first circuit board and the second circuit board are arranged and connected along a third direction. A projection of the first circuit board along the third direction at least partially overlaps a projection of the second circuit board along the third direction. The second signal trace, the second metal pad, the first metal pad, and the first signal trace are electrically connected in sequence. The first direction, the second direction, and the third direction are perpendicular to each other.

In another aspect, the present disclosure provides a camera module that includes a first unit. The first unit includes an imaging lens assembly and a first circuit board. The imaging lens assembly includes a lens set and an electronic photosensitive element, where light passes through the lens set and is incident on the electronic photosensitive element. The imaging lens set is disposed on and electrically connected to the first circuit board, and the first circuit board includes a first signal trace configured for transmitting an antenna signal.

In yet another aspect, the present disclosure provides an electronic device that includes a first unit. The first unit is a camera unit and includes an imaging lens assembly and a first circuit board. The imaging lens assembly is disposed on and electrically connected to the first circuit board, and the first circuit board includes a first signal trace configured for transmitting an antenna signal.

### BRIEF DESCRIPTION OF THE DRAWINGS

The present disclosure can be more fully understood by reading the following detailed description of the embodiment, with reference made to the accompanying drawings as follows:

FIG. 1A is a top view of an antenna module according to a first embodiment of the present disclosure.

FIG. 1B is a cross-sectional view along line 1B-1B in FIG. 1A.

FIG. 1C is a bottom view of a first unit of the antenna module in FIG. 1A.

FIG. 1D is a schematic diagram illustrating VSWR of the antenna module in FIG. 1A.

FIG. 1E is a schematic diagram illustrating antenna efficiency of the antenna module in FIG. 1A and a comparative example.

FIG. 2A is a top view of an antenna module according to a second embodiment of the present disclosure.

FIG. 2B is a cross-sectional view along line 2B-2B in FIG. 2A.

FIG. 2C is a schematic diagram illustrating VSWR of the antenna module in FIG. 2A.

FIG. 3 illustrates a top view of an antenna module according to a third embodiment of the present disclosure.

FIG. 4 is a schematic diagram of an electronic device according to a fourth embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

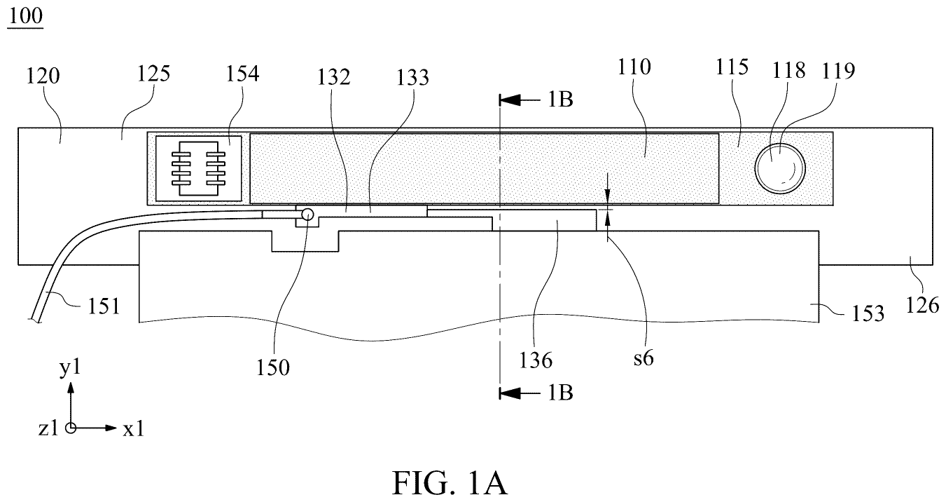

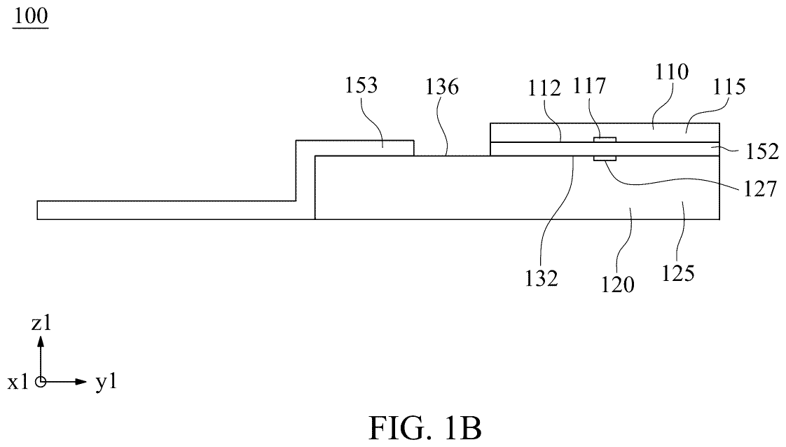

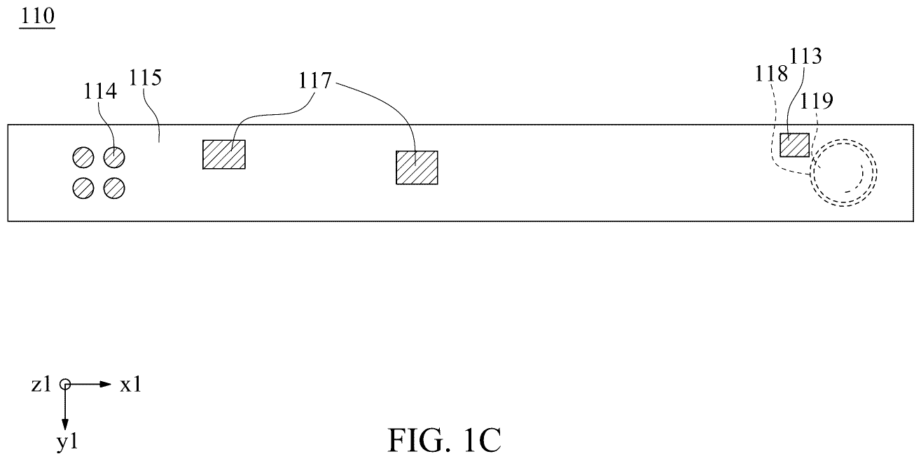

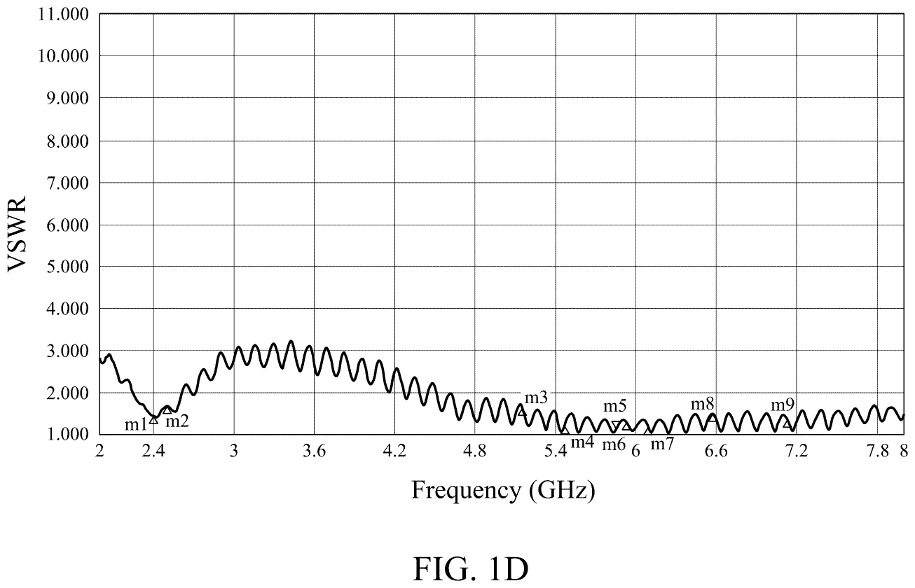

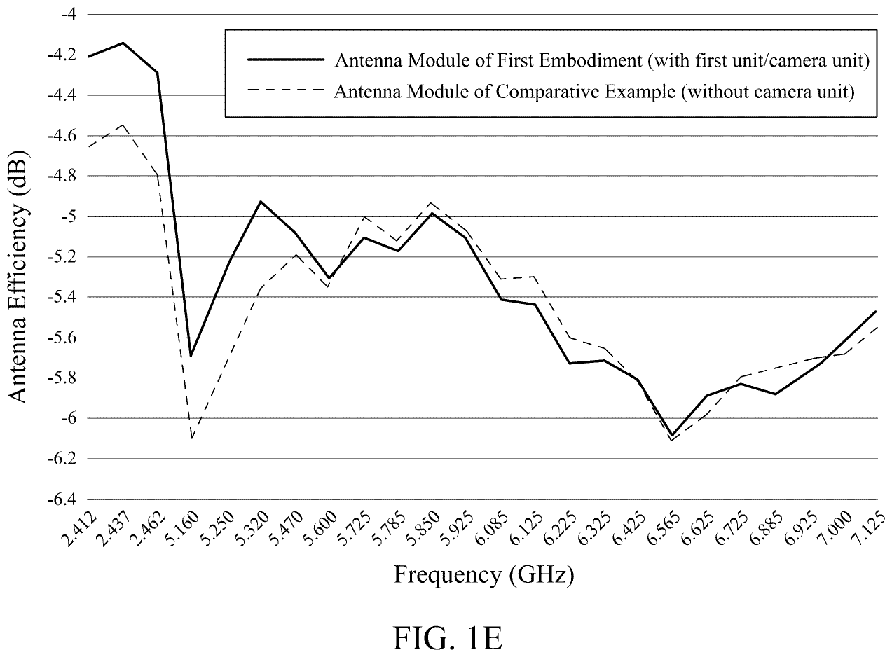

FIG. 1A illustrates a top view of an antenna module 100 according to a first embodiment of the present disclosure, FIG. 1B illustrates a cross-sectional view along the line 1B-1B in FIG. 1A, and FIG. 1C illustrates a bottom view of a first unit 110 of the antenna module 100 in FIG. 1A. Referring to FIGS. 1A to 1C, the antenna module 100 has a first direction x1, a second direction y1, and a third direction z1 perpendicular to each other. The antenna module 100 includes a first unit 110 (represented by dotted symbols in FIG. 1A) and a second unit 120.

The first unit 110 includes a first circuit board 115, which includes a first signal trace 112 and a first metal pad 117. The second unit 120 includes a second circuit board 125, which includes a second signal trace 132 and a second metal pad 127, and the second circuit board 125 is configured for disposing a feeding port 150 thereon. Each of the first circuit board 115 and the second circuit board 125 extends in the first direction x1 and the second direction y1, and the first circuit board 115 and the second circuit board 125 are arranged and connected along the third direction z1. A projection of the first circuit board 115 (first unit 110) along the third direction z1 at least partially overlaps a projection of the second circuit board 125 (second unit 120) along the third direction z1. A projection along the third direction z1 refers to a projection on the virtual plane formed by the first direction x1 and the second direction y1. The second signal trace 132, the second metal pad 127, the first metal pad 117, and the first signal trace 112 are electrically connected in sequence. Accordingly, the first unit 110 itself has a function other than that of an antenna (for example, a camera function, but the present disclosure is not limited thereto). By further using the first unit 110 as a part of the antenna radiator, space can be saved, and the antenna characteristics can be optimized by increasing the width and height of the antenna radiator. In addition, the second metal pad 127 and the first metal pad 117 may be electrically connected through a conductive adhesive element 152 (e.g., conductive glue, as shown in FIG. 1B), but the present disclosure is not limited thereto.

Specifically, the first unit 110 may be a camera unit or include an electronic photosensitive element or an image sensor (not shown in the drawings), so the antenna module 100 may also be referred to as a camera module or a composite module. As such, the antenna module 100 extends the antenna trace from the second unit 120 to the first unit 110 (camera unit), and the first unit 110 serves as part of the antenna radiator, using the metal structure of the first unit 110 to increase the radiation volume of the antenna module 100, thereby enhancing the radiation characteristics of the antenna module 100. In detail, the first unit 110 further includes an imaging lens assembly 118, which includes a lens set 119 and an electronic photosensitive element or an image sensor, where light passes through the lens set 119 and is incident on the electronic photosensitive element/image sensor. The imaging lens assembly 118 is disposed on and electrically connected to the first circuit board 115. In addition, the antenna module according to the present disclosure may include at least one of a camera unit and other functional units besides the camera unit, and the camera module according to the present disclosure may include at least one of an antenna unit and other functional units besides the antenna unit.

The first signal trace 112 may be a grounding trace or a test trace in the first unit 110. The test trace is a trace that is used for testing. As such, the first unit 110 may be a ready-made camera unit on the market, using the existing and appropriate grounding trace or test trace as part of the antenna trace, without affecting the inherent functions of the camera unit, and allowing the antenna module 100 to provide both camera and antenna functions while reducing the overall volume. In addition, during the assembly or surface mount technology (SMT) process of the first unit 110 and the second unit 120, since the body of the first unit 110 is not heat-resistant, after confirming the maximum temperature tolerance of the first unit 110, soldering using a solder furnace may be adopted, with the first unit 110 placed outside the solder furnace. Alternatively, laser soldering or micro-blow soldering may be used.

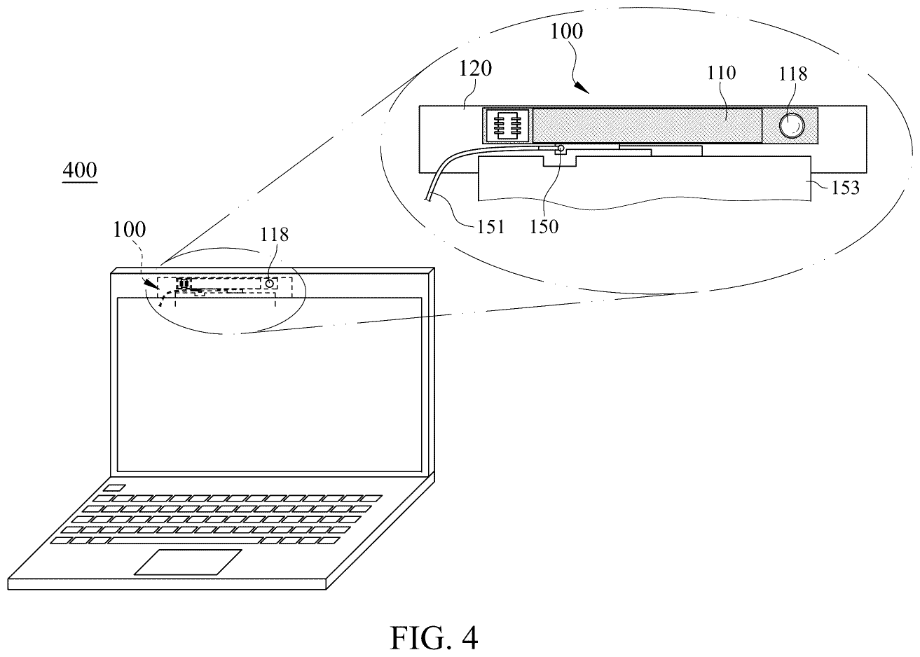

The first signal trace 112 may be not electrically connected to a system ground (e.g., a second grounding trace 136) of the second circuit board 125 through the first metal pad 117, the second metal pad 127, or other means. Accordingly, by using the first signal trace 112, which does not perform any operational function in the normal operation of the camera unit, as part of the antenna trace, the original functions of the camera unit are not affected, and the antenna performance can be enhanced. Specifically, one end of the first signal trace 112 is electrically connected to the first metal pad 117, and the other end of the first signal trace 112 is electrically connected to a shielding metal case or a camera cable of the first unit 110 (both the shielding metal case and the camera cable are not shown in the drawings and are disposed on the surface 126 of the first circuit board 115 illustrated in FIG. 1A). The first unit 110 further includes a connector 154, which is disposed on and electrically connected to the first circuit board 115, and the connector 154 is used to electrically connect the signal traces, power traces, and grounding traces related to the camera operation functions within the first unit 110 to an electronic device (e.g., the electronic device 400 shown in FIG. 4).

Referring to FIG. 1C, the number of the first metal pad 117 may be one or two. The first circuit board 115 further includes a third metal pad 113 and a fourth metal pad 114. The third metal pad 113 is a grounding metal pad related to camera operation functions and is not electrically connected to the second circuit board 125. An insulating element (not shown in the drawings) may be disposed between the third metal pad 113 and the second circuit board 125. The fourth metal pad 114 is a test metal pad related to camera operation functions and is not electrically connected to the second circuit board 125. A test metal pad is used for testing purpose.

Referring to FIGS. 1A and 1B, the second circuit board 125 may further include a second grounding trace 136, which is electrically connected to the second signal trace 132. Accordingly, through the second grounding trace 136 of the second unit 120, the antenna module 100 electrically connects to the system ground of the electronic device on which the antenna module 100 is disposed, rather than through the first signal trace 112 of the first unit 110 (camera unit), thereby reducing design complexity and preventing interference between camera functionality and antenna functionality. Furthermore, the antenna module 100 is a PIFA (Inverted-F Antenna) type antenna, and the required operating frequencies for high-frequency and low-frequency can be adjusted by adjusting the connecting position of the second grounding trace 136 and the second signal trace 132.

Referring to FIG. 1A, the second signal trace 132 may be used to dispose a feeding port 150 thereon. By extending the antenna trace from the second circuit board 125 to the first circuit board 115, the effective area of the antenna radiator can be increased in the first direction x1, the second direction y1, and the third direction z1. Furthermore, the first unit 110 further includes a feeding cable 151, which is electrically connected to the feeding port 150.

The second signal trace 132 may be located on the surface 126 of the second circuit board 125 and includes an exposed signal portion 133 and a covered signal portion (not shown in the drawings), where the exposed signal portion 133 is not covered by the first circuit board 115, and the covered signal portion is covered by the first circuit board 115. Accordingly, under the fixed size of the first unit 110 (camera unit), by selecting the overlap position and overlap proportion of the first unit 110 and the second unit 120, and the position and length of the second signal trace 132 along the first direction x1, the length of the second signal trace 132 and the overall radiation path formed by the overlapping first unit 110 and second unit 120 can be adjusted, thereby effectively adjusting the frequency offset of low and high frequencies. Furthermore, proper reduction of the overlap range of the projections of the first signal trace 112 and the second signal trace 132 on the virtual plane formed by the first direction x1 and the second direction y1 can enhance antenna characteristics.

The exposed signal portion 133 may be configured to dispose the feeding port 150 thereon. As such, the frequency offset of low and high frequencies can be effectively adjusted by adjusting the length of the radiation path.

The second grounding trace 136 may not be covered by the first circuit board 115 and is electrically connected to the exposed signal portion 133. One end of the second grounding trace 136 is electrically connected to the second signal trace 132, and the other end of the second grounding trace 136 may be electrically connected to a grounding element 153, such as copper foil (the present disclosure is not limited thereto), to electrically connect the antenna module 100 to the system ground of the electronic device. In the first embodiment, the length of the second circuit board 125 along the first direction x1 is about 40 mm, and the length of the second circuit board 125 along the second direction y1 is about 5 mm to 10 mm, but the present disclosure is not limited thereto.

The projection of the first circuit board 115 along the third direction z1 and the projection of the second grounding trace 136 along the third direction z1 may have a minimum spacing s6, where the minimum spacing s6 can be greater than or equal to 0.1 mm. Therefore, adjusting the coupling spacing helps improve antenna matching and characteristics. Furthermore, the minimum spacing s6 can be greater than or equal to 0.3 mm.

FIG. 1D illustrates a schematic diagram showing the VSWR (Voltage Standing Wave Ratio) of the antenna module 100 in FIG. 1A. FIG. 1E illustrates a schematic diagram of the antenna efficiency of the antenna module 100 in FIG. 1A and a comparative example, where the antenna module of the comparative example does not use the camera unit as the antenna radiator. Referring to FIGS. 1D and 1E, and to the data of marked points m1, m2, m3, m4, m5, m6, m7, m8, m9 in FIG. 1D listed in the following Table 1, after extending the antenna trace of the second unit 120 to the first unit 110 (camera unit), the first unit 110 may be regarded as an extension of the antenna radiator, increasing the width and height of the antenna radiator to improve the energy and bandwidth of low and high frequencies, for example, meeting the antenna specification requirements of WIFI 2.4 GHz, 5 GHz, and WIFI 6E. In particular, the extension of the antenna radiator to the first unit 110 enhances the width and height of the low-frequency radiation element, making the antenna module 100 more advantageous for low-frequency antenna characteristics.

TABLE 1

| Marked Point | Frequency (GHZ) | VSWR |
|---|---|---|
| m1 | 2.4 | 1.43 |
| m2 | 2.5 | 1.68 |
| m3 | 5.15 | 1.68 |
| m4 | 5.47 | 1.20 |
| m5 | 5.85 | 1.11 |
| m6 | 5.925 | 1.30 |
| m7 | 6.085 | 1.21 |
| m8 | 6.565 | 1.47 |
| m9 | 7.125 | 1.39 |

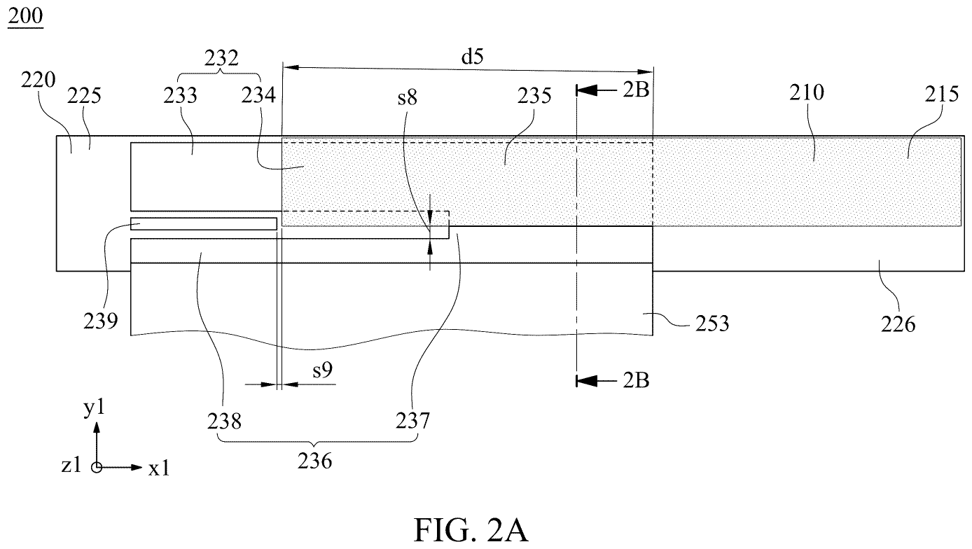

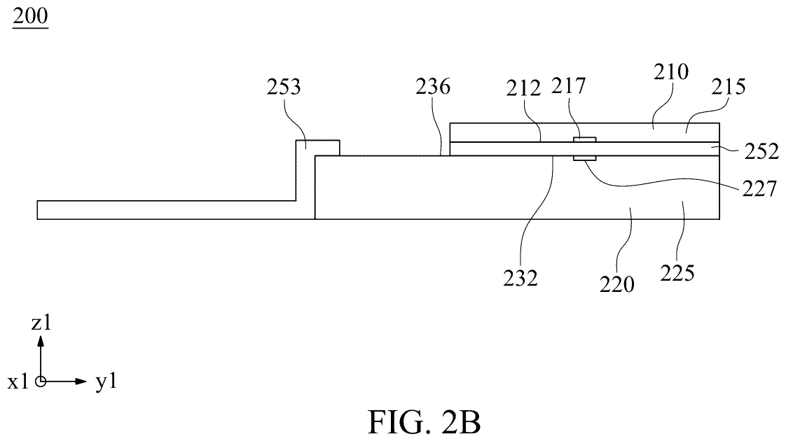

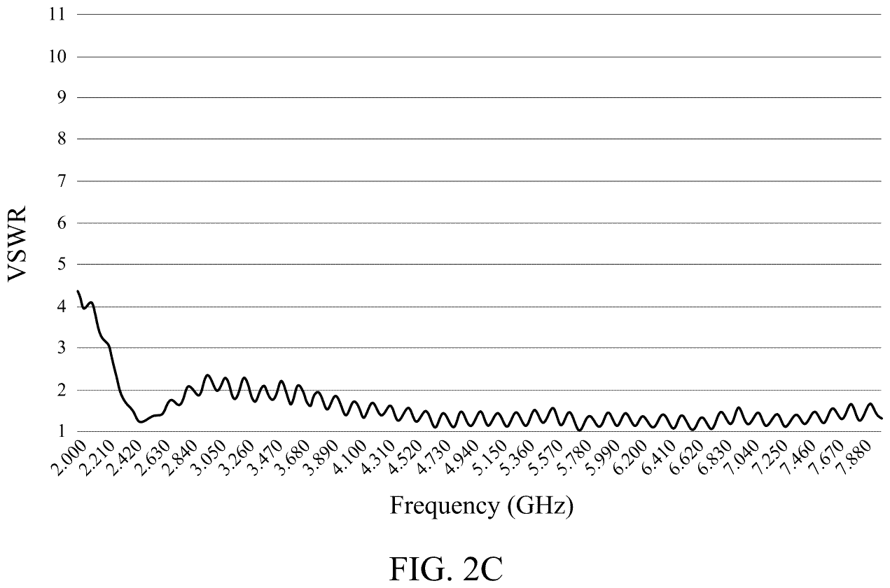

FIG. 2A illustrates a top view of an antenna module 200 according to a second embodiment of the present disclosure, and FIG. 2B illustrates a cross-sectional view along the line 2B-2B in FIG. 2A. Referring to FIGS. 2A and 2B, the antenna module 200 has a first direction x1, a second direction y1 and a third direction z1 perpendicular to each other. The antenna module 200 includes a first unit 210 (represented by dotted symbols in FIG. 2A) and a second unit 220.

The first unit 210 includes a first circuit board 215, which includes a first signal trace 212 and a first metal pad 217. The second unit 220 includes a second circuit board 225, which includes a second signal trace 232 and a second metal pad 227, and the second circuit board 225 is used for disposing a feeding port thereon (not shown in the drawings). Each of the first circuit board 215 and the second circuit board 225 extends in the first direction x1 and the second direction y1, and the first circuit board 215 and the second circuit board 225 are arranged and connected along the third direction z1. A projection of the first circuit board 215 along the third direction z1 at least partially overlaps a projection of the second circuit board 225 along the third direction z1. The second signal trace 232, the second metal pad 227, the first metal pad 217, and the first signal trace 212 are electrically connected in sequence. In addition, the second metal pad 227 and the first metal pad 217 can be electrically connected through a conductive adhesive element 252.

Specifically, the first unit 210 is a camera unit or includes an electronic photosensitive element or an image sensor (not shown in the drawings), so the antenna module 200 may also be called a camera module or a composite module. The first signal trace 212 is a grounding trace or a test trace of the first unit 210, and the first signal trace 212 may be not electrically connected to a system ground (e.g., a second grounding trace 236) of the second circuit board 225 through the first metal pad 217, the second metal pad 227, or other means. The second circuit board 225 further includes a second grounding trace 236 electrically connected to the second signal trace 232.

Referring to FIG. 2A, the second signal trace 232 is located on the surface 226 of the second circuit board 225 and includes an exposed signal portion 233 and a covered signal portion 234, where the exposed signal portion 233 is not covered by the first circuit board 215, and the covered signal portion 234 is covered by the first circuit board 215. The projection of the first circuit board 215 along the third direction z1 overlaps the projection of the covered signal portion 234 along the third direction z1, forming an overlap region 235, and the length d5 of the overlap region 235 may essentially be equal to a quarter (¼) wavelength of the operating frequency of the antenna module 200. Therefore, under the fixed size of the first unit 210 (camera unit), the length d5 of the overlap region 235 can be adjusted to adjust high-frequency matching.

The second circuit board 225 further includes a third signal trace 239, which is separated and coupled to the second signal trace 232, and the third signal trace 239 is configured for disposing a feeding port thereon. The relative position relationship between the third signal trace 239 and the first unit 210 (camera unit) can be adjusted to effectively adjust low and high-frequency matching.

There is a minimum spacing s9 between the projection of the first circuit board 215 along the third direction z1 and the projection of the third signal trace 239 along the third direction z1, where the minimum spacing s9 is greater than or equal to 0.1 mm. Therefore, adjusting the coupling spacing helps improve antenna characteristics. Furthermore, the minimum spacing s9 can be greater than or equal to 0.3 mm.

The second circuit board 225 further includes a second grounding trace 236, which is not covered by the first circuit board 215, and the exposed signal portion 233, the covered signal portion 234, and the second grounding trace 236 are electrically connected in sequence. Further, the second grounding trace 236 includes a connecting grounding portion 237 and a coupling grounding portion 238, and the exposed signal portion 233, the covered signal portion 234, the connecting grounding portion 237, and the coupling grounding portion 238 are electrically connected in sequence. The projection of the first circuit board 215 along the third direction z1 and the projection of the coupling grounding portion 238 along the third direction z1 have a minimum spacing s8 therein between, where the minimum spacing s8 is greater than or equal to 0.1 mm. Therefore, adjusting the coupling spacing helps improve antenna matching characteristics. Furthermore, the minimum spacing s8 can be greater than or equal to 0.3 mm. Specifically, one end of the second grounding trace 236 is electrically connected to the second signal trace 232, and the other end of the second grounding trace 236 may be electrically connected to a grounding element 253, to electrically connect the antenna module 100 to the system ground of the electronic device.

The third signal trace 239 is coupled to the coupling grounding portion 238 through the spacing on the second direction y1. Thus, the coupling grounding portion 238 may directly serve as the reference ground for the third signal trace 239 and help in the placement of a large-area copper foil for electrically connecting to the system ground of the electronic device.

FIG. 2C illustrates a schematic diagram of the VSWR of the antenna module 200 in FIG. 2A. Referring to FIG. 2C, after extending the antenna trace of the second unit 220 to the first unit 210 (camera unit), the first unit 210 may be regarded as an extension of the antenna radiator, thereby increasing the width and height of the antenna radiator to improve the energy and bandwidth of low and high frequencies. For example, the antenna specification requirements of WIFI 2.4 GHz, 5 GHz, and WIFI 6E can be met, and it is particularly advantageous for low-frequency antenna characteristics.

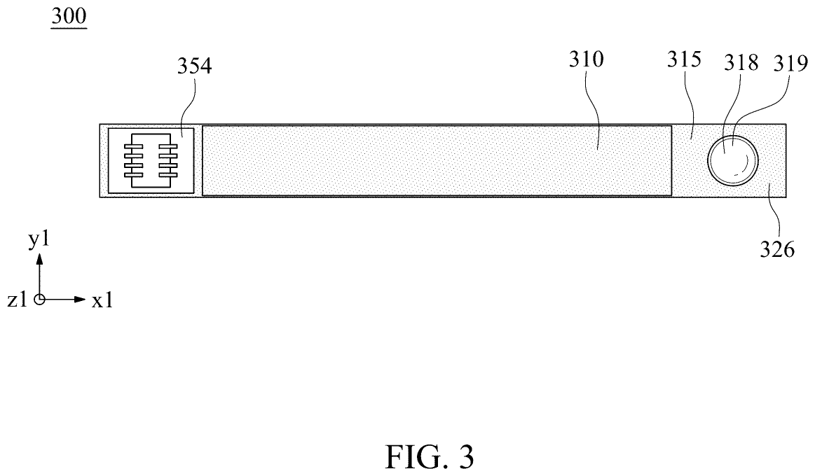

FIG. 3 illustrates a top view of an antenna module 300 according to a third embodiment of the present disclosure. Referring to FIG. 3, the antenna module 300 can also be called a camera module or a composite module, and the antenna module 300 includes a first unit 310. The first unit 310 includes an imaging lens assembly 318 and a first circuit board 315. The imaging lens assembly 318 includes a lens set 319 and an electronic photosensitive element or an image sensor (not shown in the drawings), where light passes through the lens set 319 to be incident on the electronic photosensitive element. The imaging lens assembly 318 is disposed on and electrically connected to the first circuit board 315, and the first circuit board 315 includes a first signal trace (not shown in the drawings), which is used to transmit antenna signals. Accordingly, by using the first signal trace of the camera unit, which does not perform any operational function in normal operation of the camera unit, as an antenna trace, the original functions of the camera unit are not affected, and the antenna module 300 can provide both camera and antenna functions while reducing the overall volume.

In detail, at least part of the first signal trace is located on a surface (such as surface 326) of the first circuit board 315 and is used to provide a feeding port thereon (not shown in the drawings). The first circuit board 315 further includes a first grounding trace (not shown in the drawings), which is electrically connected to the first signal trace and located on the surface of the first circuit board 315. As such, the antenna module 300 electrically connects to the system ground of the electronic device, on which it is disposed, through the specially designed first grounding trace, thereby reducing design complexity and preventing interference between camera functions and antenna functions.

Furthermore, in the third embodiment, the first signal trace is a grounding trace or a test trace of the first unit 310, and is not directly electrically connected to the system ground of the electronic device. The test trace is used for testing purpose. The first unit 310 further includes a connector 154, which is disposed on and electrically connected to the first circuit board 315.

FIG. 4 illustrates a schematic diagram of an electronic device 400 according to a fourth embodiment of the present disclosure. Referring to FIGS. 1A to 1C and FIG. 4, the electronic device 400 includes the antenna module, camera module, or composite module according to the present disclosure, such as the aforementioned antenna module 100, 200, 300, but not limited thereto. Specifically, the electronic device 400 is a notebook computer and includes the antenna module 100 of the first embodiment. The antenna module 100 includes the first unit 110 and is disposed on the upper frame of the display of the electronic device 400. The first unit 110 is a camera unit and includes the imaging lens assembly 118 and the first circuit board 115. The imaging lens assembly 118 is disposed on and electrically connected to the first circuit board 115, and the first circuit board 115 includes the first signal trace 112, which is used to transmit antenna signals. Hence, by using the first signal trace 112 of the camera unit, which does not perform any operational function when the camera unit is in normal operation, as the antenna trace, the antenna module 100 can provide both camera and antenna functions while reducing the overall volume, thereby facilitating integration and design within the limited space of the electronic device 400.

Specifically, the first circuit board 115 further includes the first metal pad 117, and the electronic device 400 further includes the second unit 120. The second unit 120 includes the second circuit board 125, which includes the second signal trace 132 and the second metal pad 127, and the second unit 120 is used to dispose the feeding port 150 thereon. The first circuit board 115 and the second circuit board 125 are arranged and connected along the third direction z1. The projection of the first circuit board 115 along the third direction z1 at least partially overlaps the projection of the second circuit board 125 along the third direction z1. The second signal trace 132, the second metal pad 127, the first metal pad 117, and the first signal trace 112 are electrically connected in sequence. The first signal trace 112 is a grounding trace of the first unit 110, and the first signal trace 112 may be electrically connected to the system ground of the electronic device 400 without the first metal pad 117 and the second metal pad 127. Therefore, design complexity is reduced, and interference between camera functions and antenna functions is avoided.

For other details of the antenna module 100 included in the electronic device 400, please refer to the content of the first embodiment above, which will not be detailed herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna module comprising:
a first unit, comprising a first circuit board, and the first circuit board comprising a first signal trace and a first metal pad; and
a second unit, comprising a second circuit board, and the second circuit board comprising a second signal trace and a second metal pad, wherein the second circuit board is configured for disposing a feeding port;
wherein each of the first circuit board and the second circuit board extends in a first direction and a second direction, and the first circuit board and the second circuit board are arranged and connected along a third direction, a projection of the first circuit board along the third direction at least partially overlaps a projection of the second circuit board along the third direction, and the second signal trace, the second metal pad, the first metal pad, and the first signal trace are electrically connected in sequence;
wherein the first direction, the second direction, and the third direction are perpendicular to each other.

2. The antenna module according to claim 1, wherein the first unit is a camera unit or comprises an electronic photosensitive element.

3. The antenna module according to claim 1, wherein the first signal trace is a grounding trace or a test trace of the first unit.

4. The antenna module according to claim 3, wherein the first signal trace is not electrically connected to a system ground of the second circuit board through the first metal pad and the second metal pad.

5. The antenna module according to claim 1, wherein the second circuit board further comprises a second grounding trace electrically connected to the second signal trace.

6. The antenna module according to claim 1, wherein the second signal trace is configured for providing the feeding port.

7. The antenna module according to claim 1, wherein the second signal trace is located on a surface of the second circuit board and comprises an exposed signal portion and a covered signal portion, the exposed signal portion is not covered by the first circuit board, and the covered signal portion is covered by the first circuit board.

8. The antenna module according to claim 7, wherein the exposed signal portion is configured for providing the feeding port.

9. The antenna module according to claim 7, wherein the second circuit board further comprises a second grounding trace electrically connected to the exposed signal portion and not covered by the first circuit board.

10. The antenna module according to claim 9, wherein there is a minimum spacing between the projection of the first circuit board along the third direction and a projection of the second grounding trace along the third direction, and the minimum spacing is greater than or equal to 0.1 mm.

11. The antenna module according to claim 7, wherein the projection of the first circuit board along the third direction overlaps with a projection of the covered signal portion along the third direction to form an overlap region, and a length of the overlap region is substantially equal to a quarter wavelength of an operating frequency of the antenna module.

12. The antenna module according to claim 7, wherein the second circuit board further comprises a third signal trace, which is separated and coupled to the second signal trace, and the third signal trace is configured for disposing the feeding port.

13. The antenna module according to claim 12, wherein there is a minimum spacing between the projection of the first circuit board along the third direction and a projection of the third signal trace along the third direction, and the minimum spacing is greater than or equal to 0.1 mm.

14. The antenna module according to claim 12, wherein the second circuit board further comprises a second grounding trace, which is not covered by the first circuit board, and the exposed signal portion, the covered signal portion, and the second grounding trace are electrically connected in sequence.

15. The antenna module according to claim 14, wherein the second grounding trace comprises a connecting grounding portion and a coupling grounding portion, and the exposed signal portion, the covered signal portion, the connecting grounding portion, and the coupling grounding portion are electrically connected in sequence;
wherein there is a minimum spacing between the projection of the first circuit board along the third direction and a projection of the coupling grounding portion along the third direction, and the minimum spacing is greater than or equal to 0.1 mm.

16. The antenna module according to claim 15, wherein the third signal trace is coupled to the coupling grounding portion.

17. A camera module, comprising:
a first unit, comprising:
an imaging lens assembly, comprising a lens set and an electronic photosensitive element, wherein light passes through the lens set and is incident on the electronic photosensitive element; and
a first circuit board, comprising a first signal trace configured for transmitting an antenna signal, wherein the imaging lens assembly is disposed on and electrically connected to the first circuit board.

18. The camera module according to claim 17, wherein at least part of the first signal trace is located on a surface of the first circuit board and is configured for disposing a feeding port, and the first circuit board further comprises a first grounding trace, which is electrically connected to the first signal trace and located on the surface of the first circuit board.

19. An electronic device, comprising:
a first unit, which is a camera unit and comprises an imaging lens assembly and a first circuit board, wherein the imaging lens assembly is disposed on and electrically connected to the first circuit board, and the first circuit board comprises a first signal trace, which is configured for transmitting an antenna signal.

20. The electronic device according to claim 19, wherein the first circuit board further comprises a first metal pad, the electronic device further comprises:
a second unit, comprising a second circuit board, which comprises a second signal trace and a second metal pad, wherein the second unit is configured for providing a feeding port;
wherein the first circuit board and the second circuit board are arranged and connected along a third direction, a projection of the first circuit board along the third direction at least partially overlaps a projection of the second circuit board along the third direction, and the second signal trace, the second metal pad, the first metal pad, and the first signal trace are electrically connected in sequence;
wherein the first signal trace is a grounding trace of the first unit, and the first signal trace is not electrically connected to a system ground of the electronic device through the first metal pad and the second metal pad.
